(19) United States
(12) Patent Application Publication
(10) Pub. No.: US 2015/0241627 A1
(43) Pub. Date: Aug. 27, 2015

(54) TOOL-LESS, WATERPROOF LIGHT PIPE

(71) Applicant: Cisco Technology, Inc., San Jose, CA (US)

(72) Inventors: Art Farnsworth, Austin, TX (US); Ron Lutz, Round Rock, TX (US); Tom Spivey, Pleasanton, CA (US)

(73) Assignee: Cisco Technology, Inc., San Jose, CA (US)

(21) Appl. No.: 14/192,684

(22) Filed: Feb. 27, 2014

(51) Int. Cl. F21V 8/00

(52) U.S. Cl. CPC G02B 6/0096

(57) ABSTRACT

This technology includes a light pipe designed to be inserted into a housing without a tool creating a seal within the housing to prevent water ingress. Retention of the light pipe is achieved by self-locking features on the light pipe and the water ingress is prevented by a compressed sealing component.

### TECHNICAL FIELD

The present technology relates generally to a light pipe, and more specifically to a light pipe that is configured to be installed in a housing without use of a tool.

### BACKGROUND

Light pipes are generally used to transmit light from one location to another. One use for light pipes is in electronic housings. A circuit board within an electronic device may have LEDs connected to the circuit board that illuminate to communicate various states of the electronic device. Such electronic devices typically have a housing to protect the circuit board from physical or electrical damage. A light pipe can be placed within the housing to transmit light from the LED on the circuit board and display it on the outside of the housing.

Typically, these light pipes are inserted into a housing utilizing an installation tool and may be retained by mechanical means, such as being threaded with a screwdriver, held by a light pipe clamp, or affixed by welding or adhesive. Requiring installation tools, additional components, or additional processes constitutes an additional sub-step within the assembly process, lengthening the manufacturing time of the completed assembly.

In addition, a void or receptacle created in a housing presents an opportunity for liquid to penetrate the housing which may potentially damage the electronic circuitry or mechanical elements inside the housing. Some electronic equipment is placed where it may be exposed to moisture, and, thus, it is required to be waterproof to promote correct function and longevity. The amount of resistance to water ingress can be evaluated by ingress protection testing standards such as IP67.

### BRIEF DESCRIPTION OF THE DRAWINGS

Certain features of the subject technology are set forth in the appended claims. However, the accompanying drawings, which are included to provide further understanding, illustrate disclosed aspects and together with the description serve to explain the principles of the subject technology. In the drawings:

FIG. 1 is an exemplary side view of an embodiment of a light pipe and sealing component, in the form of an o-ring, which is assembled onto the light pipe;

FIG. 2 is an exemplary graphical projection of an embodiment of a light pipe and sealing component, in the form of an o-ring, which is assembled onto the light pipe;

FIG. 3 is an exemplary cross-sectional view of an embodiment of a light pipe and sealing component, in the form of an o-ring, which are inserted into a receptacle within a housing;

FIG. 4 is an exemplary side view of an embodiment of a light pipe and sealing component, in the form of a bellows, which is assembled onto the light pipe;

FIG. 5 is an exemplary graphical projection of an embodiment of a light pipe and sealing component, in the form of a bellows, which is assembled onto the light pipe;

FIG. 6 is an exemplary cross-sectional view of an embodiment of a light pipe and sealing component, in the form of a bellows, which are inserted into a receptacle within a housing;

FIG. 7 is an exemplary side view of an embodiment of a light pipe and sealing component, in the form of a bellows, which is assembled onto the light pipe;

FIG. 8 is an exemplary graphical projection of an embodiment of a light pipe and sealing component, in the form of a bellows, which is assembled onto the light pipe;

FIG. 9 is an exemplary cross-sectional view of an embodiment of a light pipe and sealing component, in the form of a bellows, which are inserted into a receptacle within a housing;

FIG. 10 is an exemplary side view of an embodiment of a light pipe and sealing component, in the form of an o-ring, which is assembled onto the light pipe;

FIG. 11 is an exemplary embodiment of a light pipe and sealing component, in the form of an o-ring, which is assembled onto the light pipe; and

FIG. 12 is an exemplary cross-sectional view of an embodiment of a light pipe and sealing component, in the form of an o-ring, which are inserted into a receptacle within a housing.

### DETAILED DESCRIPTION

The detailed description set forth below is intended as a description of various configurations of the subject technology and is not intended to represent the only configurations in which the subject technology can be practiced. The appended drawings are incorporated herein and constitute a part of the detailed description. The detailed description includes specific details for the purpose of providing a more thorough understanding of the subject technology. However, it will be clear and apparent that the subject technology is not limited to the specific details set forth herein and may be practiced without these details. In some instances, structures and components may be shown in block diagram form in order to avoid obscuring the concepts of the subject technology.

### Overview

The disclosed technology addresses the need in the art for a light pipe that can be easily installed without an installation tool and can provide sufficient sealing to prevent water ingress. The present technology involves a light pipe, a sealing component, and a receptacle within a housing. The housing contains a receptacle in the form of a substantially round opening, which passes from inside the housing to outside the housing. The receptacle further comprises a counterbored section on the outside of the housing. The light pipe is generally cylindrical in shape. It is designed to be inserted into the housing without the need for a tool, such that it passes from near the outside of the housing to near the inside of the housing. The tool-less installation is achieved by self-locking features on the light pipe. The sealing component is designed to be positioned around the light pipe and within the counterbored area of the receptacle. The sealing component is compressed between the light pipe and receptacle, so that the sealing component creates a watertight seal within the housing. Several possible embodiments of the present technology are disclosed herein. However, the described embodiments are not meant to be limiting, and persons of ordinary skill in the art will appreciate many potential variations that are within the level of skill in the art. Further, while aspects of the present technology will be described as embodiments, it will be appreciated that aspects of one embodiment are usable with other embodiments, and such is explicitly contemplated herein.

### Light Pipe

A light pipe transmits light from inside a housing to outside the housing and disperses the light outside of the housing, often to act as a notification signal. The light may be static or variable (e.g. flashing or non-continuous) and may be of one or more colors. The light pipe 10 can be made from a polymer or other materials that allow light transmission. As will be understood by persons of ordinary skill in the art, material selection may also be a factor of the desired retention feature.

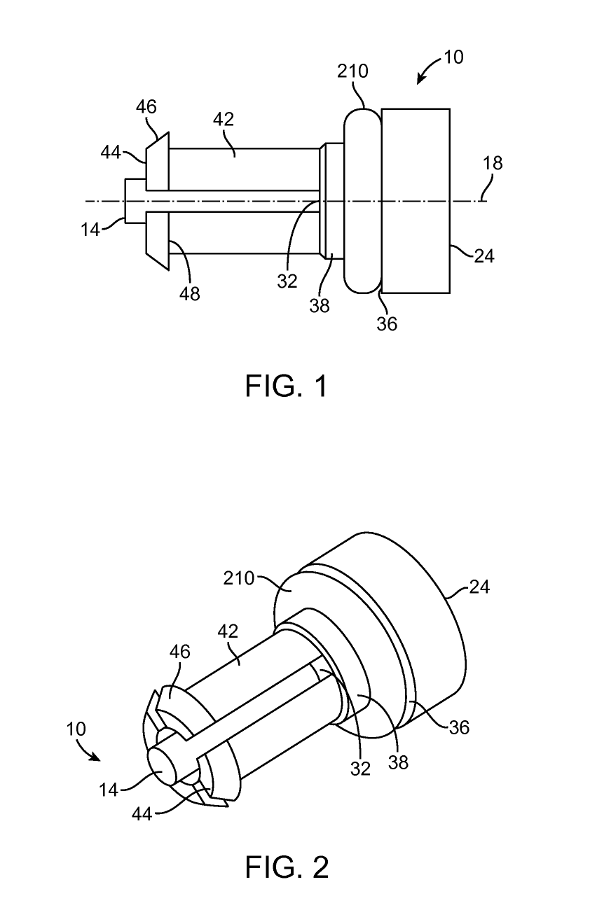

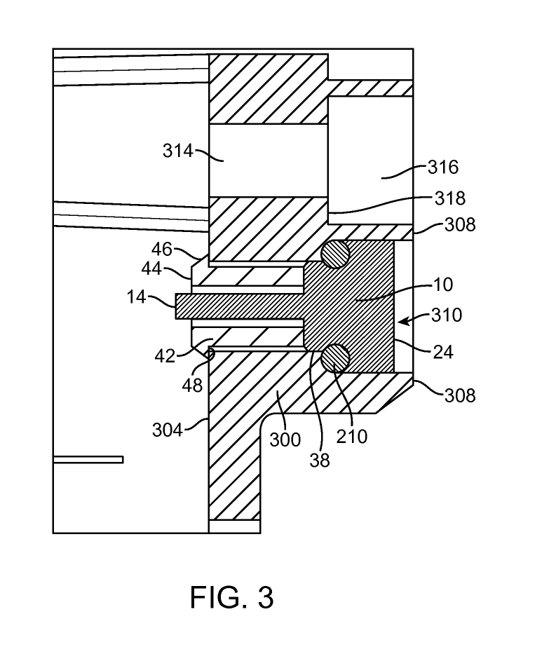

As illustrated in the various views, the light pipe 10 has a generally cylindrical shape with a first end 14 that is configured to be inserted into a housing, and remain located near the inside surface of the housing 304 or inside of the receptacle (typically in close proximity to the light source). The light pipe also has a second end 24 that is configured to be located on or near the outside of the housing 308 when the first end 14 of the light pipe 10 is within the housing. In some embodiments, the second end 24 is larger in diameter than the first end 14. The difference in diameter between the first end 14 and second end 24 occurs in a substantially step-wise manner in at least one location along the axis of the light pipe, creating intermediate faces at the transitions. As illustrated in FIG. 1 and FIG. 2, the light pipe has a first intermediate face 32 and second intermediate face 36 at the transition(s) between the different diameters.

The light pipe 10 includes a retention feature configured to allow a tool-less installation and retention within the receptacle. In some embodiments, the retention feature is comprised of multiple cantilevered arms 42. As illustrated in FIG. 1 and FIG. 2, the arms 42 can be fixed at a base that is located on the first intermediate face 32 of the light pipe. The opposite end of the arms 42 are located near the first end 14 of the light pipe. The arms 42 are constructed to be elastically deformable toward the central axis 18 of the light pipe. The arms further contain a locking extension 44, which is an area of increased diameter that is larger than the receptacle. When the light pipe 10 is inserted into the receptacle, the locking extensions 44 on the arms 42 are deformed inward as a result of a chamfer 46 located on the leading face. When the light pipe 10 is fully inserted into the receptacle 310, as illustrated in FIG. 3, the locking extensions 44 are positioned within the housing but just outside of the receptacle, allowing the arms 42 to elastically return to their original position. The increased diameter of the locking extension creates a locking face 48 that contacts the inner wall of the housing and prevents the light pipe from displacement toward the outside of the housing.

The light pipe 10 also has a sealing shoulder 38, which is configured as the surface of the light pipe 10 that interfaces with the sealing component. Thus, the sealing shoulder 38 is characterized by a smooth surface at least where it interfaces with the sealing component. As illustrated in FIG. 1 and FIG. 2, the sealing shoulder 38 is located between the first intermediate face 32 and second intermediate face 36.

### O-ring

In some embodiments, the sealing component is characterized by an o-ring 210. As illustrated in FIG. 1 and FIG. 2, the o-ring 210 is assembled onto the light pipe 10 by being inserted over the first end 14 of the light pipe and over the locking extensions 44. The o-ring 210 is then positioned on the sealing shoulder 38 of the light pipe such that it is adjacent to second intermediate face 36.

The sealing component, such as o-ring 210, can be manufactured from a rubber, polymer, or other material that can be deformed and able to create a watertight seal.

Receptacle:

In some embodiments, the receptacle 310 is in the form of a round hole 314 with a counter bore 316. At the end of the counter bore, there is a sealing face 318 at the transition between the two different diameters of the receptacle. As illustrated in FIG. 3, when the light pipe is inserted, the o-ring 210 is squeezed between the sealing face 318 of the receptacle and the second intermediate face 36 of the light pipe. The resulting force causes the o-ring 210 to deform and creates a seal within the receptacle. The light pipe, o-ring, and receptacle are dimensioned such that an appropriate amount of force is inherently applied to the o-ring 210 when the light pipe is fully inserted and the locking extensions on the arms spring into place.

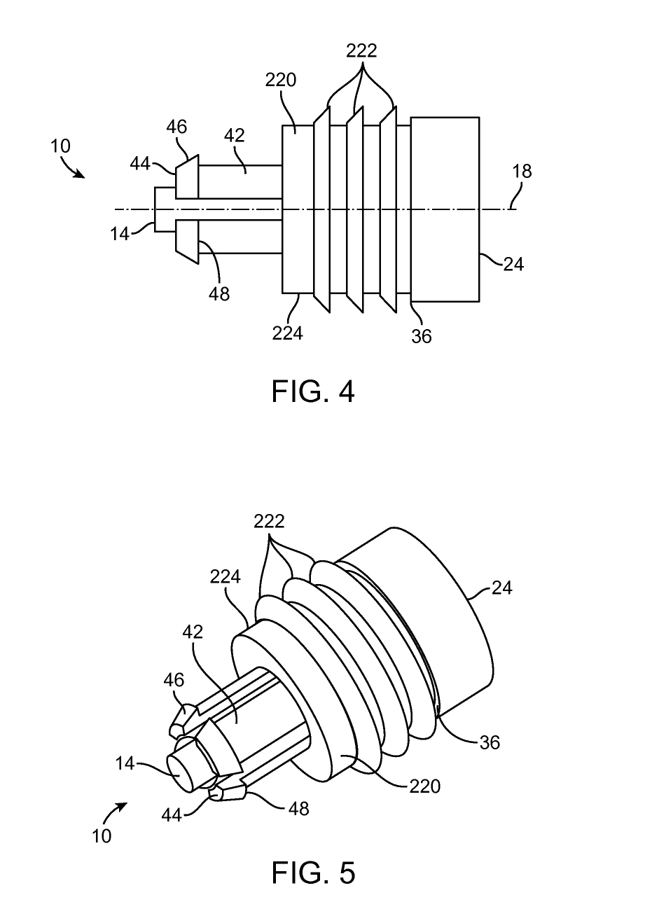

FIG. 4 illustrates an exemplary embodiment utilizing a bellows 220 as the sealing component. The bellows 220 contains one or more flexible fins 222 that extend to a diameter greater than the base 224 of the bellows. The base 224 of the bellows may be a constant diameter or it may taper from one side to the other. The fins 222 of the bellows may be shaped symmetrically or asymmetrically. An example of an asymmetric shape is the saw tooth pattern illustrated in FIG. 4. If there are multiple fins, the maximum outer diameter of each fin may be equal or the maximum outer diameter of each fin may taper from one end to the other.

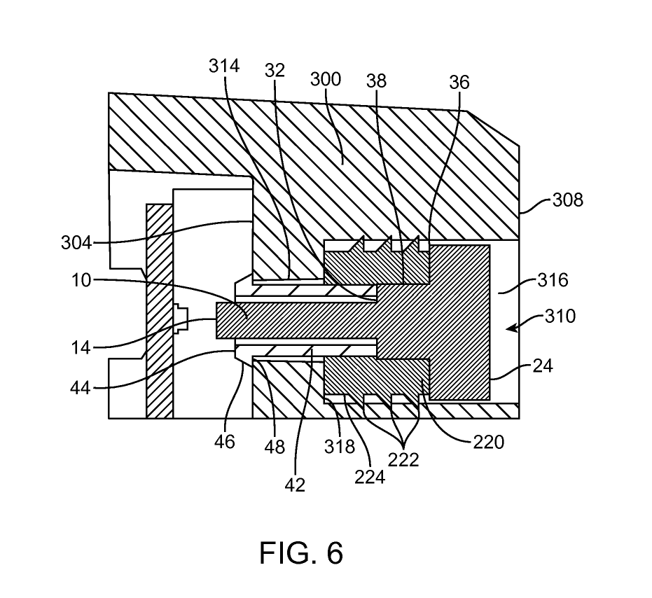

As illustrated in FIG. 5, the bellows is assembled onto the light pipe 10 by being inserted over the first end 14 of the light pipe and over the locking extensions 44. The bellows 220 is then positioned on the sealing shoulder 38 (covered, but shown in FIG. 6) of the light pipe such that it is adjacent to second intermediate face 36. The bellows may be retained to the light pipe by way of an adhesive or by the bellows being a compression fit on the light pipe.

As illustrated in FIG. 6, the receptacle 310 is in the form of a round hole 314 with a counter bore 316. At the end of the counter bore, there is a face at the transition 318 between the two different diameters of the receptacle. The outer diameter of the fins 222 of the bellows 220 is larger than the diameter of the counter bore 316. Thus, when the light pipe is inserted, the fins 222 on the bellows are squeezed and forced toward the central axis of the bellows, creating a seal within the receptacle. The light pipe, bellows, and receptacle are dimensioned such that an appropriate amount of force is inherently applied to the bellows 220 when the light pipe is fully inserted and the locking extensions on the arms spring into place.

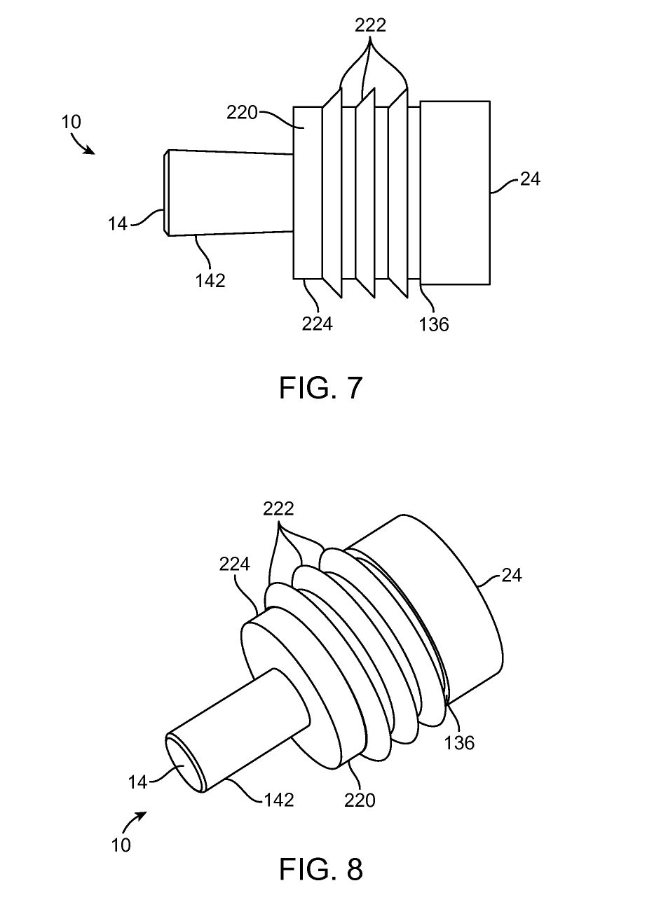

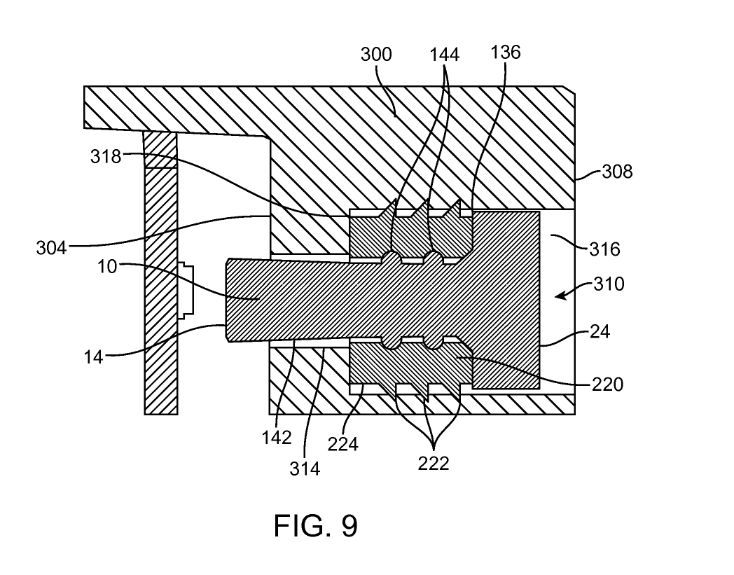

FIG. 7 illustrates an exemplary embodiment that does not utilize the cantilevered arms and locking extensions to retain the position of the light pipe. More specifically, the light pipe 10 has a generally cylindrical shape with a first end 14 that is configured to be inserted into the housing, and remain located near the inside surface of the housing 304 or inside of the receptacle (typically in close proximity to the light source). The light pipe 10 also has a second end 24 that is configured to be located on or near the outside of the housing 308 when the first end 14 of the light pipe 10 is within the housing. In some embodiments, the second end 24 is larger in diameter than the first end. In some embodiments, such as illustrated in FIG. 7, FIG. 8, and FIG. 9, the change in diameter between the first end 14 and second end 24 predominantly occurs in a step-wise manner at one location along the axis of the light pipe, creating an intermediate face 136 at the transition between the different diameters. Between the intermediate face 136 and the first end 14 of the light pipe, the light pipe has a base surface 142 in a substantially cylindrical shape.

In addition, the light pipe 10 may include one or more ridges 144 that have a diameter larger than the base surface 142, as illustrated in FIG. 9. The cross-sectional shape of the ridge(s) may be smooth, like a sine wave, or jagged and may be symmetric or asymmetric.

As illustrated in FIG. 7, the sealing component is characterized by a bellows 220. The bellows 220 contains one or more flexible fins 222 that extend to a diameter greater than the base 224 of the bellows. The base 224 of the bellows may be a constant diameter or it may taper from one side to the other. The fins 222 of the bellows may be shaped symmetrically or asymmetrically. An example of an asymmetric shape is the saw tooth pattern shown in FIG. 7. If there are multiple fins, the maximum outer diameter of each fin may be equal or the maximum outer diameter of each fin may taper from one end to the other.

As illustrated in FIG. 8, the bellows is assembled onto the light pipe 10 by being inserted over the first end 14 of the light pipe and on to the base surface 142. The bellows 220 is then positioned on top of the one or more ridges 144 (covered, but shown in FIG. 9) such that it is adjacent to intermediate face 136. The bellows may be retained to the light pipe by way of an adhesive or by the bellows being a compression fit on the light pipe.

As illustrated in FIG. 9, the receptacle 310 is in the form of a round hole 314 with a counter bore 316. At the end of the counter bore, there is a sealing face 318 at the transition between the two different diameters of the receptacle. The outer diameter of the fins 222 of the bellows 220 is larger than the diameter of the counter bore 316. Thus, when the light pipe is inserted, the fins 222 on the bellows are squeezed and forced toward the central axis of the bellows, creating a seal within the receptacle. The light pipe, bellows, and receptacle are dimensioned such that an appropriate amount of force is inherently applied to the bellows 220 when the light pipe is fully inserted. Instead of cantilevered arms, as described in other embodiments, retention is provided by the contact between the bellows and the counter bore 316. The one or more ridges 144 may increase the retention by expanding the diameter of the bellows and increase the force between the fins 222 and counter bore 316.

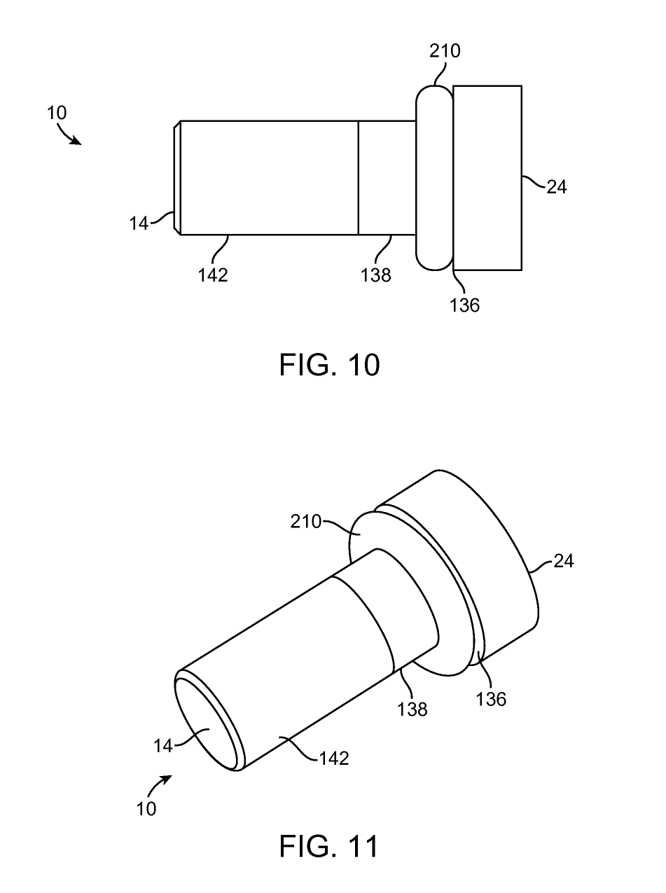

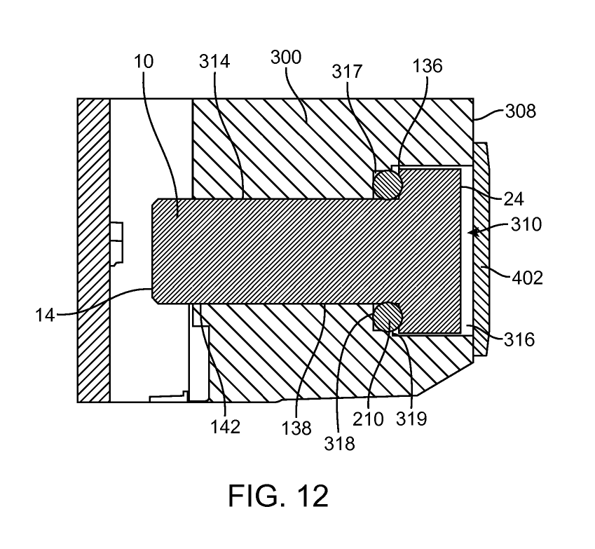

FIG. 10 illustrates an exemplary embodiment in which the light pipe 10 has a generally cylindrical shape with a first end 14 that is configured to be inserted into the housing, and remain located near the inside surface of the housing 304 or inside of the receptacle (typically in close proximity to the light source).The light pipe 10 also has a second end 24 that is configured to be located on or near the outside of the housing 308 when the first end 14 of the light pipe 10 is within the housing. In some embodiments, the second end 24 is larger in diameter than the first end. In some embodiments, such as illustrated in FIG. 10, FIG. 11, and FIG. 12, the change in diameter between the first end 14 and second end 24 predominantly occurs in a step-wise manner at one location along the axis of the light pipe, creating an intermediate face 136 at the transition between the different diameters. Between the intermediate face 136 and the first end 14 of the light pipe, the light pipe has a base surface 142 in a substantially cylindrical shape. Within this base surface 142, the light pipe 10 also includes a sealing shoulder 138, which is configured as the surface of the light pipe 10 that interfaces with the sealing component. Thus, the sealing shoulder 138 is characterized by a smooth surface at least where it interfaces with the sealing component. As illustrated in FIG. 10 and FIG. 11, the sealing shoulder 138 is located adjacent to intermediate face 136.

As illustrated in FIG. 11, the sealing component is characterized by an o-ring 210. The o-ring 210 is assembled onto the light pipe 10 by being inserted over the first end 14 of the light pipe and onto the base surface 142. The o-ring 210 is then positioned on the sealing shoulder 138 of the light pipe such that it is adjacent to the intermediate face 136.

As illustrated in FIG. 12, the receptacle 310 is in the form of a round hole 314 with a counter bore 316. At the end of the counter bore is a sealing groove 317 that has a diameter in between the counter bore 316 diameter and the diameter of the round hole 314 of the receptacle 310. At the transition between the counter bore 316 and sealing grove 317 is a limiting face 319. At the transition between the different diameters of the sealing groove 317 and the round hole 314 of the receptacle 310, there is a sealing face 318. When the light pipe is inserted, the o-ring 210 is squeezed between the sealing face 318 of the receptacle and the intermediate face 136 of the light pipe. The resulting force causes the o-ring 210 to deform and creates a seal within the receptacle. The base surface 142 of the light pipe and round hole 314 of the receptacle 310 are dimensioned such that the light pipe 10 is press fit into the round hole 314 of the receptacle 310 to provide retention. Insertion continues until the intermediate face 136 of the light pipe contacts the limiting face 319 of the receptacle. The light pipe, o-ring, and receptacle are dimensioned such that when the light pipe is fully inserted into the receptacle, an appropriate amount of force is inherently applied to the o-ring 210 to create a watertight seal.

To further retain the light pipe 10 within the receptacle 310, an adhesive label 402 is applied to the outside of the housing 308. The adhesive label 402 at least partially covers the receptacle 310 and counter bore 316. The adhesive label 402 may also provide an additional watertight seal and may help retain the light pipe 10. The adhesive label 402 may be transparent or translucent, such that light transmitted by the light pipe can be displayed on or through the sticker.

Since this embodiment does not contain cantilevered arms, it is permissible to use more rigid materials, such as glass or other ceramics, for the light pipe.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language claims, wherein reference to an element in the singular is not intended to mean “one and only one” unless specifically so stated, but rather “one or more.”

A phrase such as an “aspect” or “embodiment” does not imply that such aspect is essential to the subject technology or that such aspect applies to all configurations of the subject technology. A disclosure relating to an aspect may apply to all configurations, or one or more configurations. A phrase such as an aspect may refer to one or more aspects and vice versa. A phrase such as a “configuration” does not imply that such configuration is essential to the subject technology or that such configuration applies to all configurations of the subject technology. A disclosure relating to a configuration may apply to all configurations, or one or more configurations. A phrase such as a configuration may refer to one or more configurations and vice versa.

The word “exemplary” is used herein to mean “serving as an example or illustration.” Any aspect or design described herein as “exemplary” is not necessarily to be construed as preferred or advantageous over other aspects or designs.

What is claimed is:

1. An apparatus comprising:
a housing defining a receptacle in the form of a substantially round opening, where the opening extends from the outside of the housing to the inside of the housing, and where the opening on the outside of the housing is counter-bored;
a light pipe with a generally cylindrical shape with a first end that is located near the inside of the housing, a second end that is located near the outside of the housing, and a retention feature; and
a sealing component that is positioned around the light pipe and within the counter-bored area of the receptacle, where the sealing component is compressed between the receptacle and the light pipe.

2. The apparatus of claim 1, wherein the light pipe further comprises a first intermediate face, a second intermediate face, and a sealing shoulder between the first intermediate face and second intermediate face.

3. The apparatus of claim 2, wherein the retention feature further comprises multiple cantilevered arms fixed at a base that is located on the first intermediate face of the light pipe and where the opposite end of the arms contain locking extensions that contact an inner wall of the housing.

4. The apparatus of claim 1, wherein the sealing component is comprised of rubber.

5. The apparatus of claim 1, wherein the sealing component is an o-ring.

6. The apparatus of claim 1, wherein the sealing component is axially compressed between a sealing face of the receptacle and an intermediate face of the light pipe.

7. The apparatus of claim 1, wherein the sealing component is radially compressed between a sealing shoulder of the light pipe and the counterbore of the receptacle.

8. The apparatus of claim 1, wherein the sealing component is a bellows.

9. The apparatus of claim 8, wherein the retention feature is comprised of one or more ridges on the light pipe which interface the bellows, whereby the bellows is compressed between the one or more ridges and the counterbore.

10. The apparatus of claim 1, wherein the retention feature is a press fit between a base surface of the light pipe and the receptacle.

11. The apparatus of claim 1, wherein the sealing component is at least partially located within a sealing groove in the receptacle of the housing.

12. The apparatus of claim 1, further comprising an adhesive label applied to the outside of the housing, at least partially covering the receptacle.

13. A method comprising:
inserting a sealing component over the first end of a light pipe and onto a sealing shoulder of the light pipe;
inserting the first end of the light pipe into a counter-bored receptacle within a housing; and
providing an axial force sufficient to compress the sealing component between the light pipe and the receptacle and to engage a retention feature of the light pipe.

14. The method of claim 13, wherein the retention feature is comprised of one or more cantilevered arms on the light pipe that, during insertion of the light pipe, are elastically deformed toward the central axis of the light pipe and wherein engagement of the retention feature occurs when the light pipe is fully seated and the cantilevered arms elastically return to their original position.

15. The method of claim 13, wherein the sealing component is in the form of a bellows and wherein the retention feature is comprised of one or more ridges which compress the bellows against the counterbore.

16. The method of claim 13, wherein the sealing component is in the form of an o-ring and wherein the retention feature is comprised of the base surface of the light pipe being press fit into the receptacle.

17. The method of claim 13, wherein the sealing component undergoes axial compression between a sealing face of the receptacle and a second intermediate face of the light pipe.

18. The method of claim 13, wherein the sealing component undergoes radial compression between a sealing shoulder of the light pipe and a counterbore of the receptacle.
